(19) United States
(12) Patent Application Publication
(10) Pub. No.: US 2020/0275239 A1
(43) Pub. Date: Aug. 27, 2020

(54) LOCATION AND TRACKING SYSTEM

(71) Applicant: Vos Concepts LLC, Waconia, MN (US)

(72) Inventors: Bradley John Vos, Waconia, MN (US); Roger L. Roisen, Minnetrista, MN (US)

(21) Appl. No.: 16/287,723

(22) Filed: Feb. 27, 2019

(51) Int. Cl. H04W 4/029

(52) U.S. Cl. CPC H04W 4/029; H04W 4/30

(57) ABSTRACT

Parts used in a construction project are fitted with a beacon that stores a unique part number identifier. The beacon includes a sensor that senses a current geographic location of the part on which it is installed. And asset locator correlates the geographic location of the part, to a location on a site plan drawing and generates a visual display indicating the location of the part, on the site plan drawing. The asset locator also filters shop drawings to identify a location, in each drawing, where the part is to be used in the construction project.

### BACKGROUND

Construction worksites vary in size and complexity. Some worksites can be relatively small (such as a worksite where a single residential building is being erected), while others can be quite massive (such as where a multi-building complex, school, or other large building is being erected).

In all such operations, there is normally a set of construction drawings that define parts that are to be used to construct different portions of the structures being built. For instance, there may be an overall site plan drawing that may be a partial schematic, partial pictorial drawing showing an overall site plan. There may also be shop drawings (such as floor plans for individual floors or different sections of a structure).

Professional construction drawings often display a part identifying number (part ID) adjacent to a part image shown in an install location on the drawing. Each of these parts may be a specific building component that is manufactured and shipped by a manufacturer or other vendor to the location of the jobsite. Therefore, by referring to the drawings, a contractor or sub-contractor who is erecting the structure can verify that the proper part is being used at the proper place in the structure.

### SUMMARY

Parts used in a construction project are fitted with a locator beacon that stores a unique part number identifier. The beacon includes a sensor that senses a current geographic location of the part on which it is installed. An asset locator correlates the geographic location of the part, to a location on a site plan drawing and generates a visual display indicating the location of the part, on the site plan drawing. The asset locator also filters shop drawings to identify a location, in each drawing, where the part is to be used in the construction project.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a construction project architecture.

FIG. 2 is a block diagram showing one example of a computing system architecture.

FIG. 3 is a flow diagram illustrating one example of the overall operation of the architecture illustrated in FIG. 2.

FIG. 4 is a block diagram showing one example of a locator beacon.

FIG. 5 is a block diagram showing one example of a part record.

FIG. 6 is a flow diagram illustrating one example of the operation of a locator beacon.

FIG. 7 is a block diagram showing one example of an asset locator system, in more detail.

FIG. 8 is a flow diagram illustrating one example of the operation of the asset locator system, in more detail.

FIGS. 9A and 9B show examples of user interface displays.

FIG. 10 is a block diagram showing the architecture illustrated in FIG. 2, deployed in the cloud computing architecture.

FIGS. 11-13 show examples of mobile devices that can be used in the architectures shown in the previous figures.

FIG. 14 is a block diagram showing one example of a computing environment that can be used in the architectures shown in the previous figures.

### DETAILED DESCRIPTION OF ILLUSTRATIVE EMBODIMENTS

Conventional construction projects can present some difficulties. For instance, on a relatively large project, there may be multiple different sets of parts located in transport vehicles (such as semi-trailers) that are parked around the jobsite location. The jobsite location may be several square blocks, or even larger. Similarly, other parts may be stored on the ground or elsewhere around the jobsite. In some regions they may often be covered by snow, or vegetation, or other obscurants.

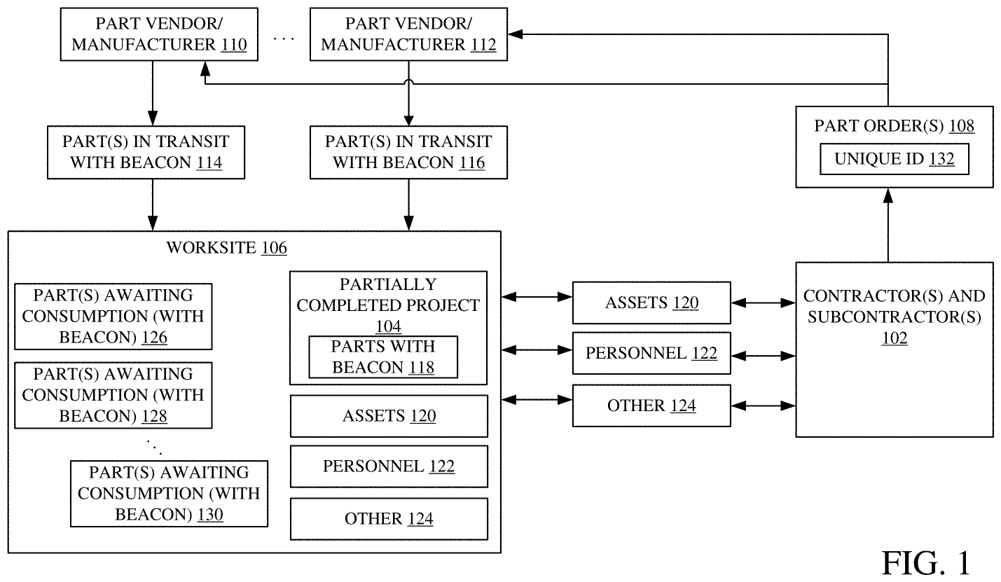

FIG. 1 is a block showing one example of a construction project architecture 100. In FIG. 1, a set of contractors and/or sub-contractors 102 are responsible for completing a construction project 104 at a worksite 106. In doing so, contractors and/or sub-contractors 102 illustratively order parts and generate part orders 108 and submit them to part vendors or manufacturers 110-112. In response, vendors/part manufacturers, 110-112 illustratively manufacture those parts and/or send them (as parts in transit 114-116) to worksite 106 where they can be incorporated as parts 118 into the project 104. Also, contractors and/or sub-contractors 102 illustratively deploy assets 120, personnel 122, and other items 124 to worksite 106 in order to complete the project 104. Assets 120 may be mobile machines (such as construction machines), tools, or other items. Personnel 122 can be sub-contractors or other works that are deployed at worksite 106 to complete project 104.

Parts that are delivered to worksite 106 but awaiting consumption are illustrated by blocks 126, 128, and 130. Those parts have been delivered from vendors and/or manufacturers 110-112 to worksite 106 and placed at different locations on worksite 106 where they are stored, until they are needed to be incorporated into project 104. When that happens, parts 126, 128 and 130 may be scattered over a number of square blocks. They may be hidden by snow, vegetation or other obscurants, or they may be disposed in transport vehicles (such as semi-trailers). This can make it difficult to find particular parts for incorporation into project 104, when they are needed.

Therefore, in one example, when contractors and/or sub-contractors 102 generate part orders 108, they include a unique identifier 132 that corresponds to the part being ordered. That unique identifier is then incorporated into a locator beacon by part vendor/manufacturers 110-112, and that locator beacon is then physically attached to the part, when it is shipped to worksite 106. In one example, the locator beacons identify the different parts and have a location sensor (such as a GPS receiver or other location sensor) that senses a geographic location of the part. Thus, at any point in time, the contractors and/or sub-contractors 102 can illustratively access (such as through a client application or otherwise) a computing system that will identify the geographic location of both the parts in transit 114-116 and the parts awaiting consumption 126, 128 and 130, located at worksite 106. This is because all of these parts illustratively have a locator beacon disposed on them.

Similarly, even the parts that have been incorporated into project 104 may still have the beacon on them. The contractors and/or sub-contractors 102 or personnel 122 (who may be carrying a mobile device), can identify the geographic location of the parts, as needed,

Also, in accordance with one example, the part numbers for the parts are also displayed on the construction drawings. Therefore, a computing system (discussed in greater detail below) processes the drawings so that a user can identify a part number on a drawing (such as by actuating it on a displayed link or icon) and the computing system displays to the user the geographic location of the corresponding part, on an overall jobsite drawing or map display. Thus, when a person wishes to locate one of the parts awaiting consumption 126-130, because it is time to use that part on project 104, the user may simply need to pull up a construction drawing that has that part number on it, actuate the part number link in the construction drawing, and the system displays an overall worksite drawing that shows a position of that part awaiting consumption, on the worksite. Similarly, if a worker is looking at a part awaiting consumption (such as parts 186), the worker may have a mobile device that reads the locator beacon for the corresponding part. The computing system then displays, in a shop drawing, where that part is to be used in project 104. All of these and other features of the present system are described in greater detail below.

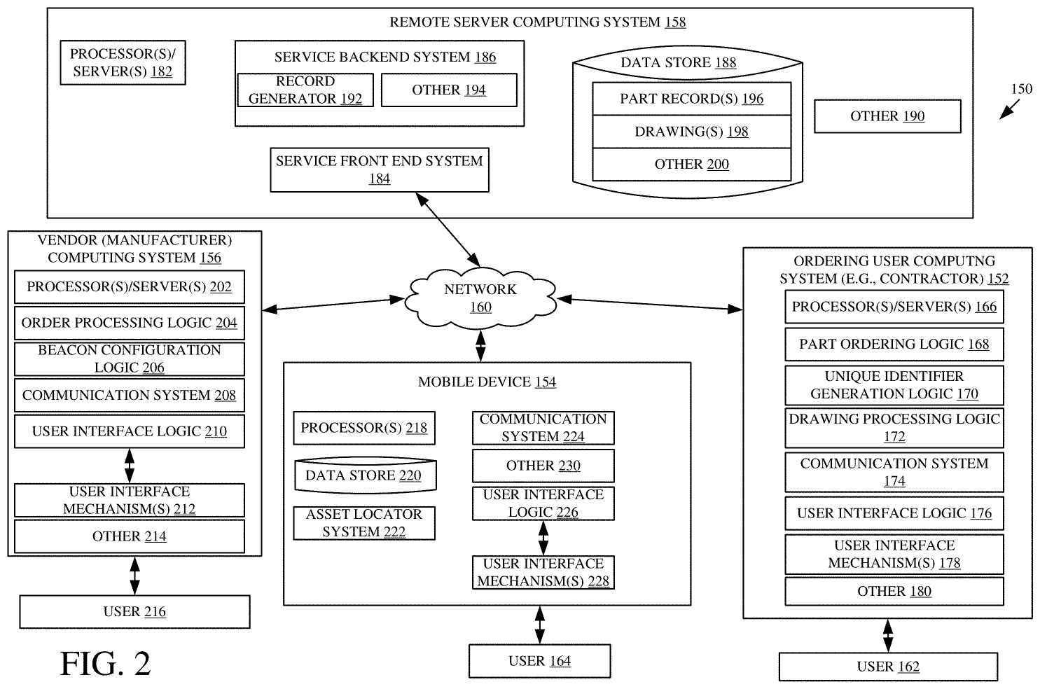

FIG. 2 is a block diagram showing one example of a computing system architecture 150 that can be used as described above with respect to FIG. 1. Therefore, computing system architecture 150 illustratively has an ordering user computing system 152 (which may be used by contractors and/or sub-contractors 102 in FIG. 1), a mobile device 154 (that may be used by the contractors and/or sub-contractors 102 or personnel 122 on worksite 106) and a vendor (or manufacturer) computing system 156 that may be deployed at the part vendor's/manufacturer's facility 110-112. Similarly, architecture 150 illustratively includes a remote server computing system 158. Systems 152, 154, 156 and 158 can be coupled for communication with one another over network 160. Network 160 can include a wide area network, a local area network, a near field communication network, a cellular communication network, or any of a wide variety of other networks or combinations of networks.

In the example shown in FIG. 2, remote server computing system 158 illustratively hosts a locator service that allows a user 162 of ordering user computing system 152 to order a part from a vendor at vendor (manufacturer) computing system 156. In doing so, user 162 causes computing system 152 to provide a unique identifier for that part. The service hosted by remote server computing system 158 illustratively associates that unique identifier with the part number that is being ordered at vendor computing system 156. The vendor then configures (or programs) a locator beacon with the unique identifier and attaches that locator beacon to the part, when it is manufactured and sent to the worksite. When remote server computing system 158 associates the unique identifier with the part number, it also generates a part number record that associates that part with the construction drawings that include that part number. Also, the locator beacon includes a positioning system (such as a GPS receiver, or other positioning system) that identifies the position of the locator beacon (and thus the part that it is attached to) and intermittently sends that information to remote server computing system 158. Computing system 158 intermittently updates the part number record with the current location (and optionally other information discussed below).

Construction workers at the worksite 106 may have mobile devices 154. The mobile devices 154 can be used in a number of different ways. The user 164 of mobile device 154 may illustratively approach a part on the worksite, and use mobile device 154 to read the locator beacon to identify the part. The mobile device 154 may also run an application (that interacts with the locator service hosted by remote server computing system 158) to allow user 164 to view all drawings that have that part number on them. Thus, user 164 can view a floor plan drawing, or other shop drawing, that identifies a location where that part will be used. In another example, user 164 may be viewing a shop drawing that has a part number on it, and may actuate a link or icon corresponding to that part number. The application then indicates a current geographic location of that particular part. In doing so, the application can access the part record from remote server computing system 158, which has been updated with the current geographic location of that part. The application can display the current geographic location to user 164 in a number of different ways. It can pull up a worksite drawing and display a location of the part on that drawing. It can launch a map application and display the current geographic location on the map display. It can display the current geographic location of the part to user 164 in a wide variety of other ways as well.

In this way, any users of the locator service hosted by remote server computing system 158 (who are properly authorized) can identify the geographic location of the various parts that are being provided by the different vendors or manufacturers. If they have already been delivered to the worksite, the users can identify the geographic location of those parts at the worksite. The users can also identify where, in the construction project, they have been, or will be, used. If the parts are still in transit, or are still at the location of the vendor or manufacturer, the users can identify that as well. In addition, users who are closely proximate the part, so that their mobile device can read the locator beacon, can view drawings that include that part on them. Thus, they can view the shop drawings that include the part, the overall worksite drawing that includes the part, or other drawings. These and other details are described in greater detail below.

Before describing the overall operation of architecture 150, a brief discussion of some of the items in architecture 150, and their operation, will first be provided. It should be noted, at the outset, that a number of items of logic and systems are shown at various locations in architecture 150. However, it will be noted that those items of logic or systems can be disposed in other locations as well, and the locations described below are described for the sake of example only.

Ordering user computing system 152 illustratively includes one or more processors or servers 166, part ordering logic 168, unique identifier generation logic 170, drawing processing logic 172, communication system 174, user interface logic 176, user interface mechanisms 178, and it can include a wide variety of other items 180. Part ordering logic 168 illustratively uses user interface logic 176 to generate user interface mechanisms 178 so that user 162 can order parts from one or more different vendor or manufacturers computing systems 156. Unique identifier generation logic 170 illustratively generates a unique identifier for that part. The unique identifier may, for instance, identify the part itself, the project that the contractor (user 162) is ordering the part for, the vendor from which the part is being ordered, etc.

Drawing processing logic 172 illustratively allows computing system 152 to upload construction drawings that may have been generated by engineers, architects, or other persons, on other computing systems. The drawing processing logic 172 illustratively identifies part numbers on those drawings that identify parts that will be able to be tracked and located using the locator service hosted by remote server computing system 158. For those parts, it illustratively adds a user actuatable element to the drawings so that when a user is viewing the drawings on a device, the parts that are trackable using the service will be visually distinguished from other part numbers. They may, for instance, be highlighted, printed in a bold or other visually distinguishable text, they may be formatted differently, they may a have different size, they may be blinking, or there may be other visual indicia that identify them as part numbers corresponding to parts that can be tracked and located by the service.

Communication system 154 illustratively allows ordering user computing system 152 to communicate with the various other systems or devices over network 160. Therefore, communication system 174 may include multiple different communication systems or a single communication system that allows it to perform these types of communications.

User interface logic 176 can illustratively generate and detect user interaction with user interface mechanisms 178. User interface mechanisms 178 may include such things as user actuatable icons, links, or other items that can be actuated using a point and click device or another device on a user interface display. Where the mechanisms are displayed on a touch sensitive screen, they may be actuated using touch gestures. Where the computing system includes speech recognition functionality, then they may be actuated or otherwise interacted with using speech commands. Mechanisms 178 can also include such things as buttons, keys, a keypad, a keyboard, touch pads, audio, visual or haptic devices, etc. Logic 176 detects user interaction with the user input mechanisms and generates an indication of that user interaction to other items in system 152, and possibly other systems in architecture 150.

Remote server computing system 158 illustratively includes one or more processors or servers 182, service front-end system 184, service back-end system 186, data store 188, and it can include a wide variety of other items 190. Service front-end system 184 illustratively exposes application programming interfaces (APIs) and other interfaces that can be interacted with by the various other computing systems and devices in architecture 150. It handles interaction with those systems and communication over network 160. Service back-end system 186 can include record generator 192 and other items 194. Data store 188 can include part records 196, drawings 198, and other items 200. Service front-end system 184 can receive drawings 198 from other computing systems (such as a computing system where they were generated). In doing so, it can perform processing on those drawings (like that described below with respect to drawing processing logic 172) so that the part numbers identified on the drawings, which represent parts that can be tracked and located by the locator service, are modified to include a link or other user actuatable element. They can also be modified so that they are visually distinguished on a display device from part numbers that represent parts that are not tracked by the locator service. It will be noted that service front-end system 184 can include the drawings, after they are already processed to include this information, as well. In either case, system 184 illustratively provides the drawings to service back-end system 186 where they are either processed, or where they are stored as drawings 198 in data store 188.

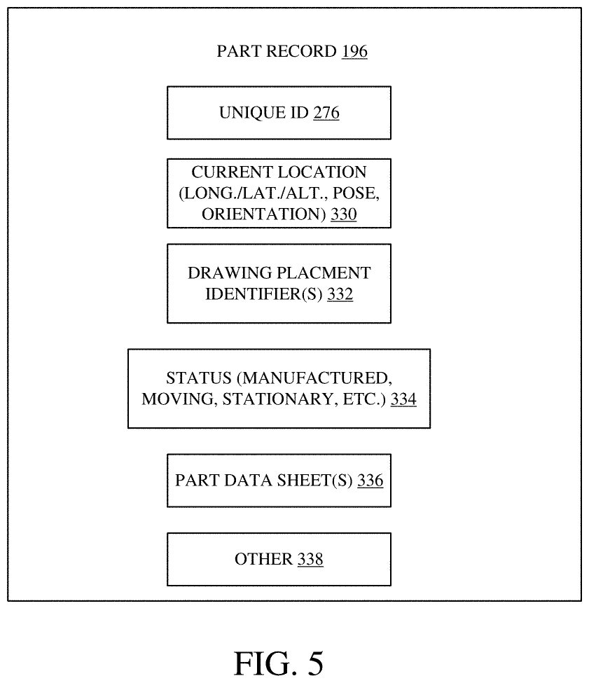

Service front-end system 184 will also receive information indicating that an ordering user computing system 152 has generated an order for a vendor or manufacturer computing system 156 that includes one or more different parts. Service front-end system 184 also includes the unique identifier that was generated by the ordering computing system 152. It provides that information to service back-end system 186. Record generator 192 then generate a record for the various parts that have been ordered, and which are trackable by the locator service being hosted by remote service computing system 158. The part records can include a wide variety of different types of information, and they are stored as part records 196 in data store 198. One example of a part record 196 is described in greater detail below with respect to FIG. 5. It will be noted that some of the part records may be predefined, or pre-generated such as for parts that are often used, for parts that are specialty parts, etc. In those cases, where the part record is pre-generated, it may be augmented with information, such as the current geographical location of the part after it is manufactured, the unique identifier assigned by the ordering computing system, or other information.

In the example shown in FIG. 2, vendor (or manufacturer) computing system 156 illustratively includes one or more processors or servers 202, order processing logic 204, beacon configuration logic 206, communication system 208, user interface logic 210, user interface mechanisms 212, and it can include other items 214. Order processing logic 204 illustratively receives orders generated from ordering user computing system 152 and processes those orders to identify the particular parts that are to be manufactured and sent to the worksite. Thus, order processing logic 204 can identify the unique part identifier generated by computing system 152. It can identify the particular part that is being ordered. It can identify the contractor or sub-contractor ordering the part, the worksite where the part is to be sent, any project identifier that identifies the project for which the part was ordered, and a wide variety of the information. Order processing logic 204 can do this by automatically parsing an order that is received to identify the various parts of the order. It can do this using optical character recognition, or other electronic parsing techniques. Similarly, this information may be tagged on an order document that is received over network 160 at vendor (or manufacturer) computing system 156, so that it can be more easily identified. These and other mechanisms for processing an order can be implemented by order processing logic 204.

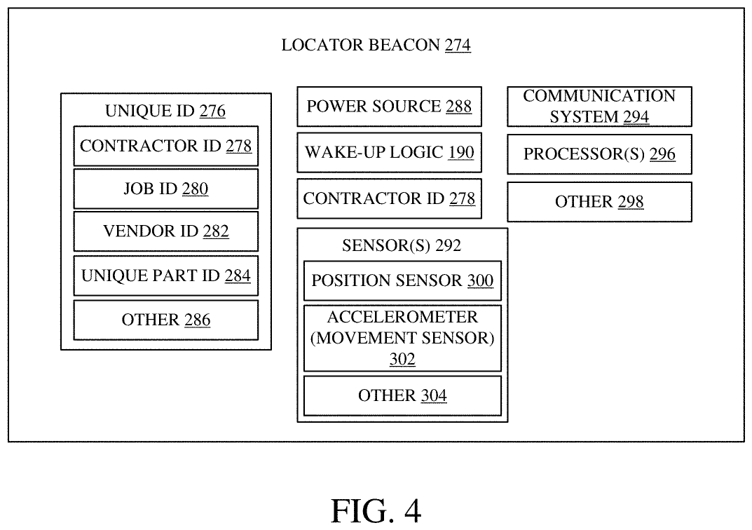

Beacon configuration logic 206 then configures a locator beacon so that it can be attached to the part prior to sending the part to the worksite. One example of a locator beacon is described in greater detail below with respect to FIG. 4. Suffice it to say, for now, that the locator beacon illustratively includes a hardware item that is physically attached to a part before it is sent to the worksite. The locator beacon can include logic that periodically senses a current geographic location of the part, and a status of the part (such as whether it is moving or stationary). It intermittently sends that information over network 160 to service front-end system 184. It is provided to record generator 192 which intermittently updates the part record 196 corresponding to that part. The updates can include updates to its physical location, its status (such as whether it is moving, stationary, awaiting consumption at the worksite, already consumed or installed, etc.).

Beacon configuration logic 206 illustratively programs the beacon with the unique identifier so that, when it is read by a mobile device 154, the mobile device 154 will be able to access the drawings that the part is referenced on. It can be read using, for example, near field communication, Bluetooth, 4.0, 4.1, 5.0, etc., or any other RF transceiver types, QR code, or the cell modem itself is pinged by the application and a visual indicator such as an LED or other type which could include any visual, audio, or haptic output device, can be actuated on the part. It will be able to display the physical geographic location of the part to the user of mobile device 154. It will be able to download information (such as material safety data sheets or other information) about the part and display it to the user of mobile device 154, and other information.

Communication system 208 illustratively allows computing system 158 to communicate with the other systems and devices over network 160. Therefore, it may include one or more different communication systems, depending on the type of communication that it is to perform.

User interface logic 210 illustratively generates and detects interactions with user interface mechanisms 212. It can provide an indication of those interactions to other items on vendor (or manufacturer) computing system 156 and/or to other items in architecture 150.

User 216 can interact with user interface mechanisms 212 in order to control and manipulate vendor (or manufacturer) computing system 156 and/or some other items in architecture 150.

Mobile device 154 illustratively includes one or more processors 218, data store 220, asset location system 222, communication system 224, user interface logic 226, user interface mechanisms 228, and it can include a large variety of other items 230. Communication system 224 illustratively allows mobile device 154 to communicate with other systems or devices over network 160. Therefore, as with the other communication systems, it can include one or more different types of communication systems, depending on what types of communications it is to perform. User interface logic 226 illustratively generates and detects interactions with user interface mechanisms 228. Therefore, user 164 can interact with user interface mechanisms 228 in order to control and manipulate mobile device 154 and some other items in architecture 150.

Asset locator system 222 can be a client-side component of the locator service hosted by remote server computing system 158. In another example, it can be a stand-alone application that interacts with the locator service hosted by remote server computing system 158. In either case, or in other scenarios, it can be accessed by user 164 in order to interact with the locator beacons, on physical parts, or to interact with the part numbers on drawings, in order to locate different parts or assets. By way of example, when user 164 is viewing a shop drawing on mobile device 154, and that shop drawing includes a part number that is actuatable (that represents a part that can be tracked and located using the locator service hosted by remote server computing system 158), user 164 can actuate the link or other actuatable item corresponding to that part number. In response, asset locator system 222 can use communication system 224 to obtain the current part record 196 for the part corresponding to that part number. Information in that part record 196 can then be displayed to user 164.

By way of example, it may be that user 164 is attempting to locate the physical location of that part on the worksite 106. In that case, asset locator system 222 can identify the geographic location of that part and display it to user 164 in one of a variety of different ways. It can identify a corresponding location on an overall site plan drawing and display the location of the part on that site plan drawing. In another example, it can launch a mapping application and display the physical geographic location of the part on a map display generated by the mapping application. In another example, relative signal strength indication can be used to identify the distance and direction from the object. It can display the geographic position of the part in other ways as well.

In another example, it may be that user 164 is standing next to the part so that asset locator system 222 can read the locator beacon that is attached to that part. It can then display information about the part, or it can display a shop drawing that indicates the part number for that part, and where the part will be used in the construction project 104. These and other items of functionality are described in greater detail below.

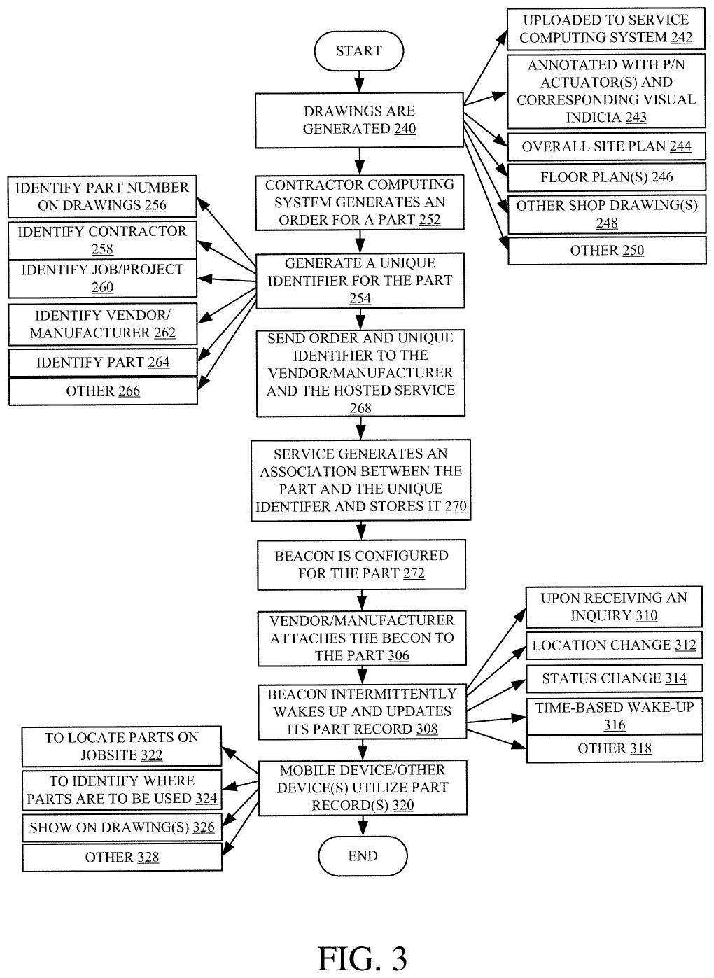

FIG. 3 is a flow diagram illustrating one example of the overall operation of architecture 150, in more detail. It is first assumed that a set of construction drawings has been generated. This is indicated by block 240 in the flow diagram of FIG. 3. They are then illustratively uploaded to remote server computing system 158. There they can be stored as drawings 198 in data store 188. This is indicated by block 242. At some point, the drawings are illustratively processed so that they are annotated with part number actuators and corresponding visual indicia which identify them as parts that are being tracked by remote server computing system 158. Annotating the drawings in this way is indicated by block 243. As discussed above, this can be done when the drawings are generated. It can be done by an ordering user computing system 152 (such as by the contractor or sub-contractor ordering the parts). It can be done at remote server computing system 158 as well.

It will also be noted that not every part number on a drawing need have an actuator. For instance, it may be that only certain parts are tracked by the locator service hosted by remote server computing system 158. Those parts may be parts available from certain vendors or manufacturers, different classes of parts that are available (such as structural items but not connectors—screws, nuts and bolts, etc.), parts that are of a sufficient size, specialty parts, or other different subsets of parts.

The drawings may be in different forms. They can include a variety of different drawings. They can include an overall site plan 244, floor plans 246, other shop drawings 248, or a wide variety of other items 250.

At some point a contractor or sub-contractor uses ordering user computing system 152 to generate an order for a part. This is indicated by block 252. The order can be generated from the drawings, or separately. It can be generated in electronic form, or in paper form, or in other ways.

At some point, a unique identifier is generated for the part that has been ordered. This is indicated by block 254. It can be generated by the unique identifier generation logic 170 at the ordering user computing system 152 or by other logic at remote server computing system 158 or elsewhere. Generating a unique identifier for the part is indicated by block 254. The unique identifier can identify the part number on the drawings, as indicated by block 256. It can identify the contractor or sub-contractor who is ordering the part, as indicated by block 258. It can identify the job or project for which it is being ordered, as indicated by block 260. It can identify the vendor or manufacturer from which the part is being ordered, as indicated by block 262, and it can identify the part itself (in a way that may be different from the part number). This is indicated by block 264. The unique identifier can include a wide variety of other items as well, and this is indicated by block 266.

Unique identifier generation logic 170 can include a wide variety of different types of functionality for doing this. It can be a random number generator, it can be a hash algorithm that takes the part number, an identifier for the vendor and the contractor and hashes them together, or it can include a wide variety of other logic.

Once the order is generated, and the part being ordered is uniquely identified, then the order and the unique identifier are sent to the vendor or manufacturer computing system 156 as well as to the remote server computing system 158 that is hosting the locator service. This is indicated by block 268 in the flow diagram of FIG. 3.

Record generator 192 then generates an association between the part that has been ordered and the unique identifier, and creates a part record 196 (if it is not already created) for that part and stores that record in data store 188. Generating the association between the part and the unique identifier and storing it is indicated by block 270 in the flow diagram of FIG. 3.

Beacon configuration logic 206 also configures the locator beacon for the part being ordered. This is indicated by block 272 in the flow diagram of FIG. 3.

Before proceeding with the description of FIG. 3, a brief description of one example of a locator beacon will first be provided. FIG. 4 shows an example of a locator beacon 274. Beacon 274 illustratively includes memory that can be configured by beacon configuration logic 206 to store the unique identifier 276, such as near field communication, Bluetooth or any other types of transceiver as well as QR code reading mechanism. In the example shown in FIG. 4, the unique identifier, itself, illustratively includes a contractor identifier 278 that identifies the contractor who ordered the part. It includes a job identifier 280 that identifies the job, for that contractor, and a vendor or manufacturer identifier 282 that identifies the vendor or manufacturer that is configuring the locator beacon and attaching it to the part. It can include a unique part identifier 282 that uniquely identifies that part and distinguishes it from other parts. This may be the part number itself, a variation of the part number, or a different number. The unique identifier can include a wide variety of other items 286 as well.

Locator beacon 275 also illustratively includes a power source 288, which may be a battery, a solar powered system, a secondary (rechargeable) battery, or another power source. It illustratively includes wake-up logic 290, one or more sensors 292, a communication system 294, one or more processors 296, and it can include other items 298. Sensors 292 can include a position sensor 300, an accelerometer or other movement sensor 302 and other sensors 304.

Wake-up logic 290 illustratively wakes up the functionality of locator beacon 274, intermittently, based on a set of wake-up criteria. It uses communication system 294 to send updated information to remote server computing system 158 so that its part record 196 can be updated with that information. The information can include the current day and time, as well as information from sensors 292, and other information. FIG. 5 is a block diagram showing one example of a part record 196. In the example shown in FIG. 5, the part record includes the unique identifier 276 (described above with respect to FIG. 4). It can include the current location (such as longitude, latitude, altitude) of the locator beacon 274 (and thus of the part it is attached to). This is indicated by block 330. It can have drawing placement identifiers that identify the various different drawings where that part number may be located. The drawing placement identifiers are indicated by block 332. It can include a status of the locator beacon (and thus the part). This is indicated by block 334. The status may include such things as manufactured, shipped, moving, stationary, delivered, installed, etc.

Referring again to FIG. 4, and by way of example, position sensor 300 may include a GPS receiver, or another position sensor that senses a geographic location of locator beacon 274 (and thus the part it is attached to). Accelerometer 302 may sense whether locator beacon 274 is in motion or is stationary. This can be done by another movement sensor as well, such as a gyroscopic sensor or other sensor. The information generated by sensors 292 can be sent, using communication system 294, to remote server computing system 158 where record generator 192 updates the part record 196 with the current location and status of the part, and along with the date and time that the record was updated, etc.

Returning again to FIG. 3, the vendor or manufacturer that is sending the part to the worksite illustratively attaches the beacon 274 to the part. This is indicated by block 306 in the flow diagram of FIG. 3. The attachment can be by a permanent physical attachment (such as by using an adhesive, welding, etc.). It can be by a temporary attachment mechanism as well. In one example, when the part is installed at the project on the worksite, the locator beacon is removed so that it can be reused. This is just one example.

After the beacon is attached to the part, it intermittently wakes up and updates its parts record and geolocation. This is indicated by block 308. This can be done in a wide variety of different ways. For instance, it may be that a user (such as a user of mobile device 154) sends a request to the locator beacon 274 on the part to wake-up and update its information. Waking up in response to an inquiry, in this way, is indicated by block 310. In another example, position sensor 300 may be continuously or intermittently active. When it senses a change in position of the locator beacon 274 (and thus the part it is attached to) this may cause wake-up logic 290 to wake-up and update the part record. Waking up in response to a location change is indicated by block 312.

Similarly, the movement sensor 302 may indicate that the status of the part has changed (from stationary to moving). This may cause wake-up logic 290 to wake-up and update the part record. This is indicated by block 314.

Wake-up logic 290 may wake-up for other reasons as well. For instance, it may be programmed to wake-up every 30 minutes, every 12 hours, etc. It may wake-up at different time intervals depending on its status. For instance, if movement sensor 302 indicates that the locator beacon 274 is moving, then wake-up logic 290 may wake-up and update its part record every 10 minutes. However, if movement sensor 302 indicates that the part is stationary, then wake-up logic 290 may only wake-up every hour or less. Time-based wake-up is indicated by block 316. The locator beacon 274 may wake-up and update its part record in other ways as well, and this is indicated by block 318.

Once the part record 196 is generated and updated for this part, then mobile device 154 or other computing systems 152 or 156 can utilize the part record 196 in various different ways. This is indicated by block 320. For instance, as described above, mobile device 154 can use that part record 196 to locate the geographic position on the jobsite. This is indicated by block 322. It can be used to identify where parts are to be used, based upon the shop drawings that contain the corresponding part numbers. This is indicated by block 324. It can show this information on various different drawings, as indicated by block 326. The part records can be used in a wide variety of other ways, as indicated by block 328.

The part record 196 can include data sheets describing the part (such as manufacturer or vendor data sheets, material safety data sheets, or other data sheets. This is indicated by block 336. The part record 196 can include a wide variety of other items 338 as well.]

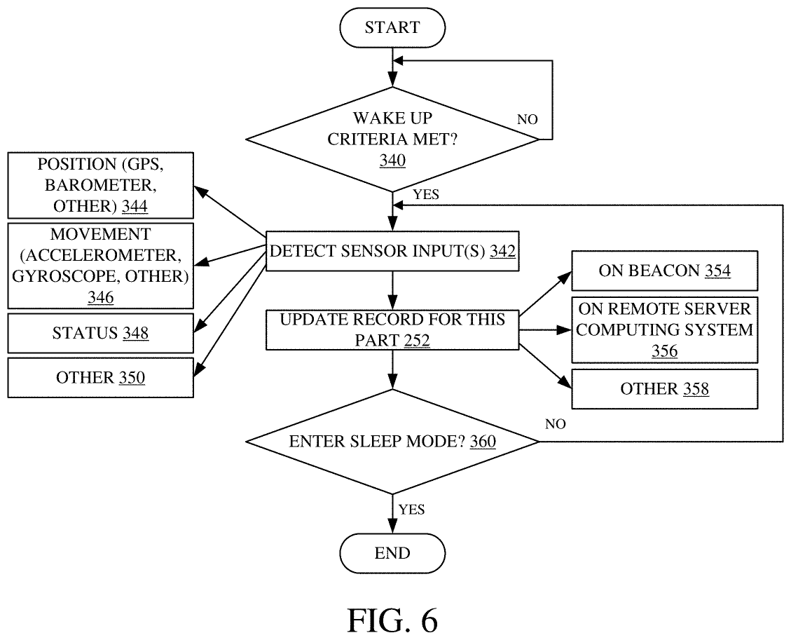

FIG. 6 is a block diagram showing one example of the operation of locator beacon 274, in more detail. In one example, locator beacon 274 uses wake-up logic 290 to determine whether it should wake-up, and update its part record 196. This may be done based on a wide variety of different wake-up criteria, some of which were described above with respect to FIG. 3. For instance, the wake-up criteria may be whether the locator beacon 274 has received a command to wake-up, or an inquiry as to its current status or location. The wake-up criteria can be whether the sensors 292 have sensed a change in location or status. The wake-up criteria can be time-based criteria or combinations of these and other criteria. Determining whether to wake-up is indicate is indicated by block 340 in the flow diagram of FIG. 6.

Once it is determined by wake-up logic 290 that locator beacon 274 is to wake-up, sensors 292 generate sensor signals indicative of the different variables that they are sensing. This is indicated by block 342. For instance, position sensor 300 generates one or more signals indicative of the current geographic position of locator beacon 274. As discussed above, the position sensor can be a GPS receiver, a barometer or other sensor that senses a variable indicative of position, pose or orientation, altitude, or other sensors. Sensing position is indicated by block 344. Movement sensor 302 may generate a sensor signal indicative of movement. This is indicated by block 346. As discussed above, the movement sensor may be an accelerometer, a gyroscope, or other sensor. Any other type of status sensor may generate an output indicative of status. This is indicated by block 348. The status may identify whether the part has been manufactured, shipped, whether it is in transit, whether it is moving or stationary, whether it has been delivered or installed, or other status. The sensor signals can include a wide variety of other sensor signals as well, and this is indicated by block 350.

In one example, locator beacon 274 may include memory that is used to store the part record 196, locally on locator beacon 274. Updating the record locally is indicated by blocks 352 and 354 in the flow diagram of FIG. 6. In addition, communication system 294 can communicate the updated information to remote server computing system 158 so that record generator 192 can update the part record 196 on data store 188. Updating the part record on the remote server computing system is indicated by block 356. The part record can be updated in other ways as well. For instance, it may be updated locally on locator beacon 274, and held there temporarily when there is no communication link available to remote server computing system 158 (such as when there is no cell coverage, etc.). At a point when that link is again available, then communication system 295 can communicate the part record that has been updated, and temporarily stored on locator beacon 274, to the remote server computing system 158. Similarly, communication system 294 can use store and forward technology. By way of example, it may be that the locator beacon 274 is in a geographic location where there is no cell communication available. However, it may be that another worksite vehicle (such as a fork lift, a skid steer loader, or another vehicle), comes close enough to locator beacon 274 that the updated part record 196 can be transmitted to that vehicle. Then, when that vehicle enters a location where cellular or other network communication is available, it uploads the part record 196 to remote server computing system 158. Updating the part record in other ways is indicated by block 358 in the flow diagram of FIG. 6.

At some point, wake-up logic 290 will determine that locator beacon 274 should again enter sleep mode, where certain items on it can be powered down. Until this occurs, processing reverts to block 342. Determining whether sleep mode should be entered is indicated by block 360 in the flow diagram of FIG. 6.

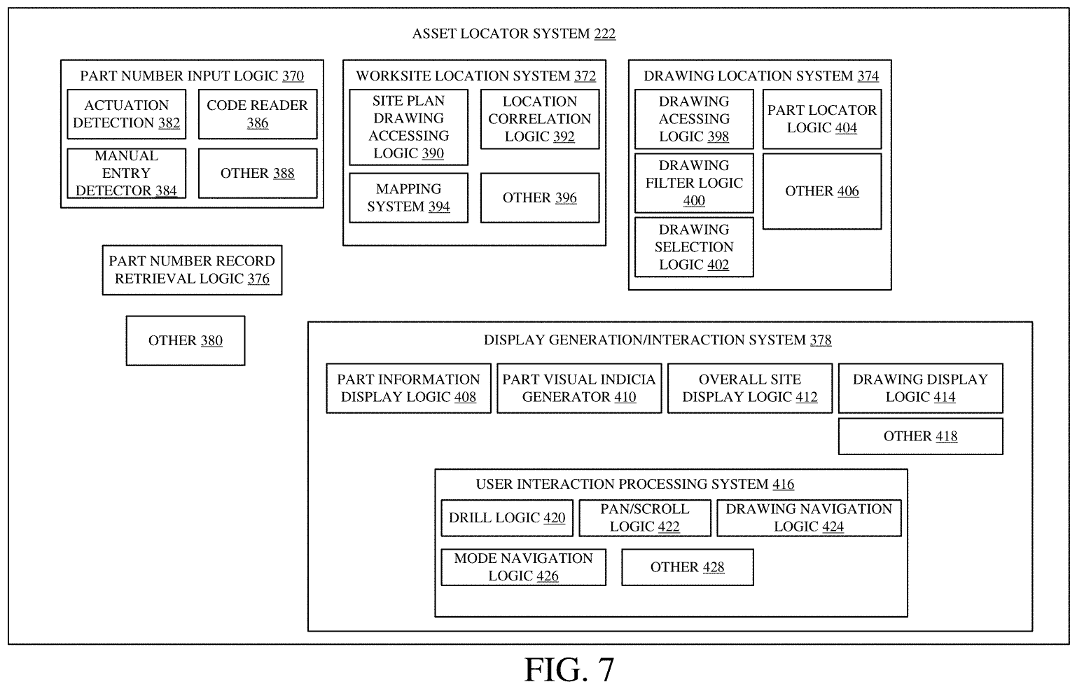

FIG. 7 is a block diagram showing one example of asset locator system 222 (briefly described above with respect to FIG. 2) in more detail. Asset locator system 222 illustratively includes part number input logic 370, work site location system 372, drawing location system 374, part number record retrieval logic 376, display generation/interaction system 378, and it can include a wide variety of other items 380. Before describing the overall operation of asset locator system 222 in more detail, a brief description of some of the items on it, and their operation, will first be provided.

Part number input logic 370 illustratively detects a part number for which information is to be retrieved and surfaced for a user. As discussed above, when a user of mobile device 154 is viewing a construction drawing, that drawing may have part numbers located on it. The part numbers may be actuatable elements, such as links or icons, that can be actuated by the user who is viewing the drawing. In that way, the corresponding part number will be selected by asset locator system 222 for processing. Obtaining the part number can thus be done by using an actuation detector 382 to detect actuation of a part number actuator.

In another example, the user may manually enter the part number off of the drawing, from memory, or from another source. Manually entering the part number is detected by manual entry detector 384.

In yet another example, asset locator system 222 includes code reader 386 that can be actuated to read information from a locator beacon 274 that is attached to a part. The part number can be input by other logic as well, as indicated by block 388.

Part number record retrieval logic 326 illustratively retrieves the part number record so that it can be used by asset locator system 222. When the part number record is stored locally on locator beacon 274, then logic 326 retrieves the part number record 196 from the locator beacon 274. When it is stored remotely on the remote server computing system 158, then part number record retrieval logic 326 illustratively retrieves it (e.g., using communication system 224) from remote server computing system 158.

Work site location system 372 can be used to identify for a user where, on a work site 106, the part is located. In one example, worksite location system 372 includes site plan drawing accessing logic 390 and location correlation logic 392. In such a scenario, site plan drawing accessing logic 390 accesses a site plan drawing of work site 106. Location correlation logic 392 can interact with a mapping system to correlate different geographic locations on the site plan drawing to geographic references (such as longitude, latitude, altitude, etc.). Once the geographic position of the locator beacon for the part is known (from the part number record 196 corresponding to that part) then location correlation logic 392 illustratively generates an output indicating where, on the site plan drawing, the part is located. This can be output to display generation/interaction system 378 where it is displayed or otherwise surfaced to the user, as is described below.

In another example, work site location system 272 includes a mapping system 394. Mapping system 394 can be launched to display a geographic location, on a map display, where the part is located, based upon the geographic position identified in its part record 196. Work site location system 372 can include other items 396 as well.

Drawing location system 374 illustratively includes drawing accessing logic 398, drawing filter logic 400, drawing selection logic 402, part locator logic 404, and it can include other items 406. Drawing accessing logic 398 illustratively accesses data store 188 or another data store where drawings 198 are stored. Drawing filter logic 400 then filters those drawings based upon the part numbers that appear on the drawings. The part numbers can be listed as metadata corresponding to the drawings, or they can be identified in other ways. Filter logic 400 uses the part number (or unique identifier) from the part record 196 to filter the drawings to identify a subset of drawings that include the identified part.

Drawing selection logic 402 then illustratively selects one of the drawings that include the part number. The drawing selection logic 402 can be configured to select the drawings in one of a variety of different ways. For instance, it can be configured to select the most detailed drawing first, and the least detailed drawing last. It can be configured to select a drawing that has the part number on it the greatest number of times. It can be configured to select drawings according to a predetermined preference hierarchy, or it can select a drawing based on a user input or in other ways.

Once a selected drawing is identified, then part locator logic 404 illustratively locates the part number of the part under analysis, on the selected drawing. It can provide an output of this to display generation/interaction system 378.

Display generation/interaction system 378 illustratively displays or otherwise surfaces information to the user of mobile device 154 in any of a wide variety of different ways. System 378 can include part information display logic 408, part visual indicia generator 410, overall site display logic 412, drawing display logic 414, user interaction processing system 416, and it can include a wide variety of other items 418. User interaction processing system 416 can include drill logic 420, pan/scroll logic 422, drawing navigation logic 424, mode navigation logic 426, and it can include other items 428.

Part information display logic 408 can illustratively display information about a part in response to a part number being detected by part number input logic 370. For instance, when a user is viewing a drawing, and the user actuates the part number actuator, then part information display logic 408 can illustratively display part information, such as data sheets provided by the manufacturer or vendor, material safety data sheets, etc. It can display this information for the user.

Part visual indicia generator 410 can illustratively generate a visual indicia on a drawing that identifies the part, on that drawing. For instance, where the user is attempting to locate the part on a work site, visual indicia generator 410 can generate visual indicia on a site plan drawing so that the user can see where, on the work site, the part is located. Where the user is attempting to locate the part on a shop drawing, the part visual indicia generator 410 generates visual indicia showing the part on that shop drawing. The visual indicia will illustratively be indicia which enhance the ability of a user to distinguish that part number from other information on the drawing. For instance, it may be highlight indicia that highlights the part number. It may be blinking indicia that causes the part number to blink, it may be a brightness or other color indicia that changes the brightness or color of the part number, or a circle around the part number. It may be an arrow that points to the part number. It may be an animation or other visual indicia as well.

Overall site display logic 412 generates a signal that displays the visual indicia on an overall site display (such as an overall site drawing, a map display, or another display that displays the overall site). Drawing display logic 414 illustratively generates an output that displays the visual indicia (generated by generator 410) on a drawing, such as a shop drawing, floor plan, etc.

Display generation/interaction system 378 may generate displays that have user actuators on them, so that the user can interact with the drawing. For instance, they may have a drill actuator that the user can actuate to drill into deeper detail (or to navigate to a drawing that has more detail) or to zoom in on a particular part of the display. The drill actuator may allow the user to also zoom out into a less detailed, more general display as well. The drawing may have a pan or scroll input that allows the user to pan or scroll the drawing. It may have a navigation input that allows the user to navigate to a different drawing, to a different operational mode, etc. Therefore, user interaction processing system 416 illustratively includes drill logic 420 that processes an input in which the user actuates a drill actuator to drill up or drill down into less or more detailed information. System 416 illustratively includes pan/scroll logic 422 that processes a user pan or scroll input to pan or scroll the display. Where the user provides a navigation input to navigate to a different drawing, drawing navigation logic 424 processes that information to retrieve the drawing that is being navigated to, and to display that drawing. Where the user provides an input indicating the user wishes to navigate to a different display mode (such as from displaying information about a part to displaying the location of the part), this is processed by mode navigation logic 426 so that the information being displayed by asset locator system 222 is displayed according to the newly selected mode.

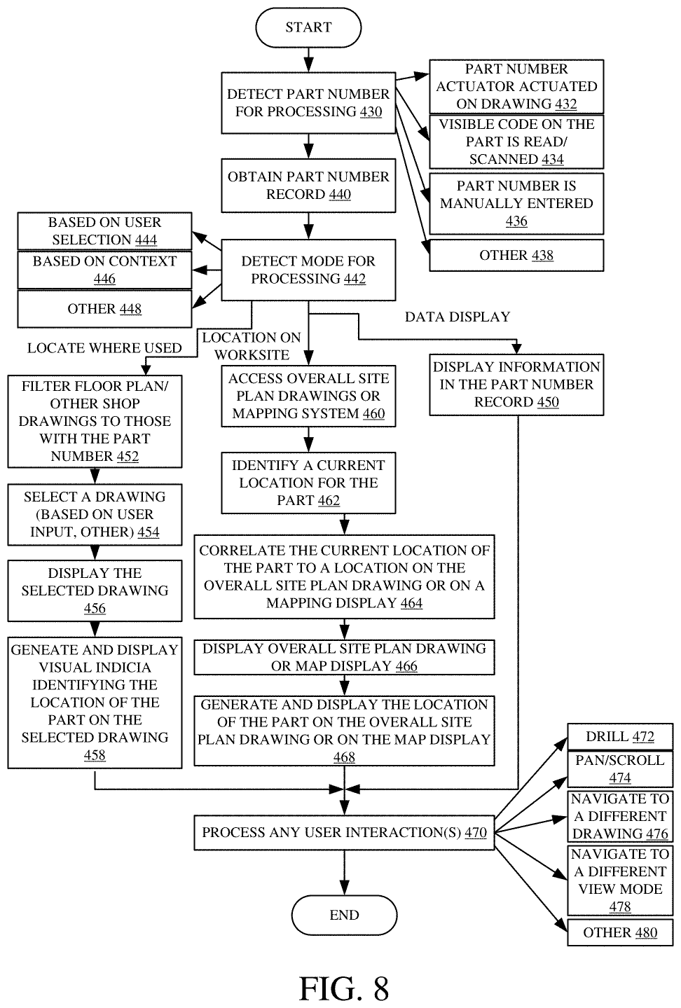

FIG. 8 is a flow diagram showing one example of the operation of asset locator system 222, in more detail. It is first assumed that part number input logic 370 detects a part number for processing. This is indicated by block 430 in the flow diagram of FIG. 8. For instance, the part number can be detected by actuation detector 382, where the user actuates a part number actuator on a drawing. This is indicated by block 432. The part number may be entered by code reader 386 where the user uses mobile device 154 to read a code on the locator beacon 274 or to read information from the locator beacon in other ways as well. Reading a visible code on the part using a reader or scanner is indicated by block 434. The user can manually enter the part number as indicated by block 436, or the part number can be detected in other ways as well. This is indicated by block 438.

Once the part number is input, then part number record retrieval logic 326 retrieves the part number record 196 (either locally from the locator beacon 274, or from remote server computing system 158) as indicated by block 440 in the flow diagram of FIG. 8. Asset locator system 222 then determines a processing mode by which the part number is to be processed. This is indicated by block 442. This can be based upon a user selection as indicated by block 444, or it can be based on context as indicated by block 446. The mode can be identified in other ways as well, and this is indicated by block 448.

For instance, it may be that the user is attempting to identify the geographic location of a part on the work site. The user may provide an input indicating this. In another example, the user may be attempting to review data corresponding to a part. The user may do this by actuating a part number actuator on a shop drawing. In that case, the context in which the user actuated the part number drawing may indicate the mode of operation of asset locator system 222.

A number of different operational modes will now be described. Assume, for instance, that the user wishes to review material or data about the part. In that case, part number display logic 408 retrieves that material from the part number record 196 corresponding to the part and displays it. The information may be information such as a material safety data sheet, promotional or other literature provided by the manufacturer or vendor, etc. The information may include other information, such as the status of the part (e.g., whether it is manufactured, in transit, etc.), the last time the part moved, or other information. Retrieving and displaying information from the part number record is indicated by block 450 in the flow diagram of FIG. 8.

It may also be that the part has already been used or installed on the project 104 at the work site 106 and the user may wish to identify the location where the part was used. In that case, drawing filter logic 400 illustratively filters the various drawings 198 corresponding to that project to identify floor plan and other shop drawings that have the corresponding part number identified on them. This is indicated by block 452 on the flow diagram of FIG. 8. Once those drawings are identified, then drawing selector logic 402 selects one of those drawings (and this can be based on a user input or based on other criteria). This is indicated by block 454. Drawing display logic 414 then displays the selected drawing, and part visual indicia generator 410 generates and displays visual indicia identifying the location of the part on the selected drawing. Displaying the selected drawing is indicated by block 456 and displaying the visual indicia identifying the part (and distinguishing it from other information displayed on the drawing) is indicated by block 458. Again, the visual indicia can include highlighting, a change of color or font corresponding to the part number, a blinking visual indicia, an arrow pointing to the part number, or some other way that visually distinguishes the part (and/or part number) on the selected drawing from the surrounding information.

It may also be that the user is attempting to locate the geographic position of the part on the work site. For instance, it may be that the part has been delivered to the work site but has not yet been used. In that case, it may be in a transport vehicle (such as a semi-trailer). It may be on the ground and obscured by snow or vegetation. Or it may be in another location. In that case, site plan drawing accessing logic 390 or mapping system 394 accesses either a site plan drawing or a mapping system, and location correlation logic 392 identifies a current location of the part, based upon the location information in the part number record for that part, and based upon the mapping system or site plan drawing. Accessing the overall site plan drawing or mapping is indicated by block 460 and identifying a current location for the part from the part record is indicated by block 462. Location correlation logic 392 then correlates the current location of the part to a location on the overall site plan drawing or on a mapping display generated by the mapping system. This is indicated by block 464 on the flow diagram of FIG. 8.

Overall site display logic 412 then generates a display of the overall work site (e.g., the overall site plan drawing or the map display) and displays that on mobile device 154. This is indicated by block 466.

Part visual indicia generator 410 then generates and displays visual indicia identifying the location of the part, on the overall site plan drawing or on the map display. This is indicated by block 468 on the flow diagram of FIG. 8.

As discussed above with respect to FIG. 7, the display may have user actuators on it so that a user can interact with the display in various ways. Thus, user interaction processing system 416 processes any user interactions with the display. This is indicated by block 470. For instance, drill logic 420 can process a drill input as indicated by block 472. Pan/scroll logic 422 can process a pan/scroll input as indicated by block 474. Drawing navigation logic 424 can process an input to navigate to a different drawing, as indicated by block 476. Mode navigation logic 426 processes an input to navigate to a different display mode or part number processing mode as indicated by block 478. Other user interactions can be processed in a wide variety of other ways as well. This is indicated by block 480.

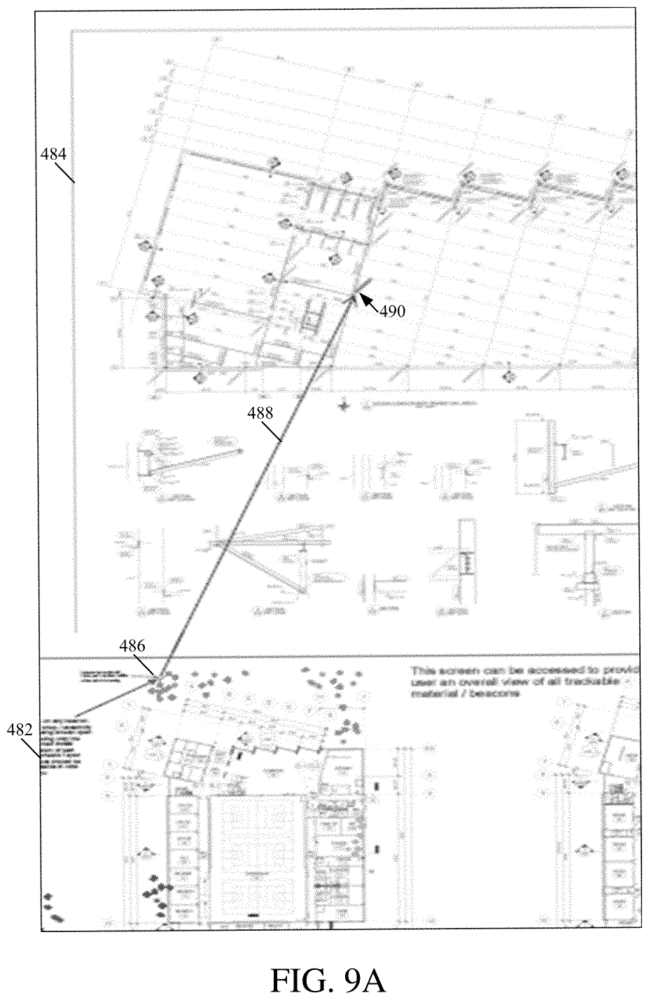

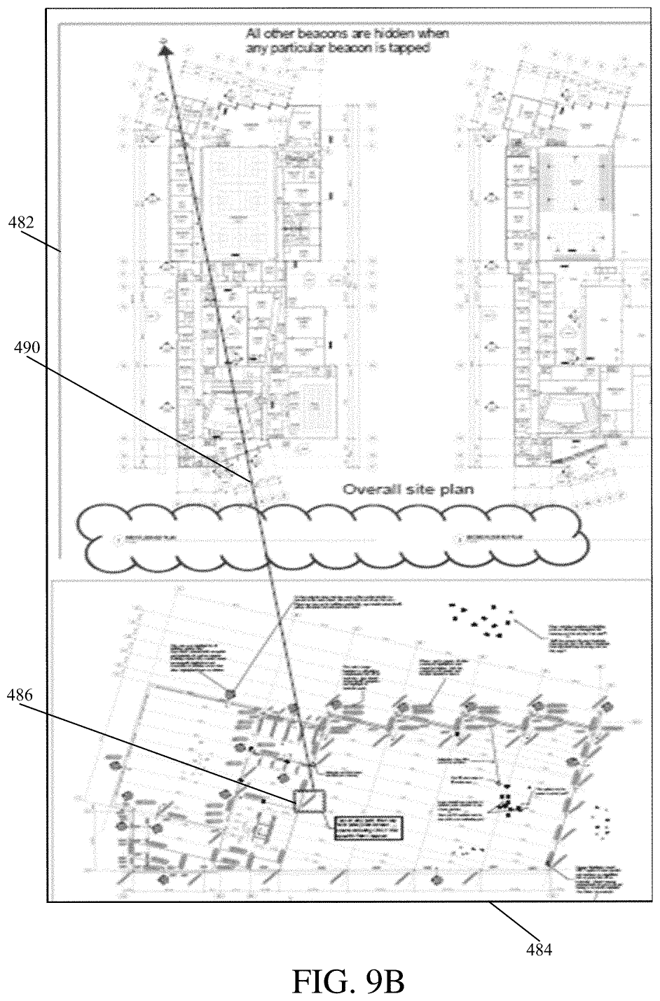

FIG. 9 shows a set of user interface displays that can be generated using the present asset locator system. FIG. 9A, for instance, shows an overall site plan view 482, and a floor plan drawing 484. The user has illustratively used asset locator system 222 (e.g., code reader 386) to read a part number from a part located generally at 486 on the work site. In that case, drawing display logic 414 displays floor plan display 484, and an arrow 488 is displayed showing where, on floor plan 484, the part number that was read at 486, is to be used on the project. This is illustrated generally at 490 in drawing 484.

FIG. 9B shows the opposite type of operation. In FIG. 9B, the user is viewing the floor plan drawing 484 and actuates a part number actuator corresponding to part 486 on the floor plan drawing. The user is attempting to locate that part, on the work site. In response, overall site display logic 412 displays the overall work site drawing 482, and part visual indicia generator 410 generates arrow 490 which points from the part actuated by the user at 486 on drawing 484 to the geographic location of that part on the work site as shown on overall site drawing 482. These are just two examples of how the asset locator system 222 and the corresponding service can be used, and a wide variety of others are contemplated herein as well.

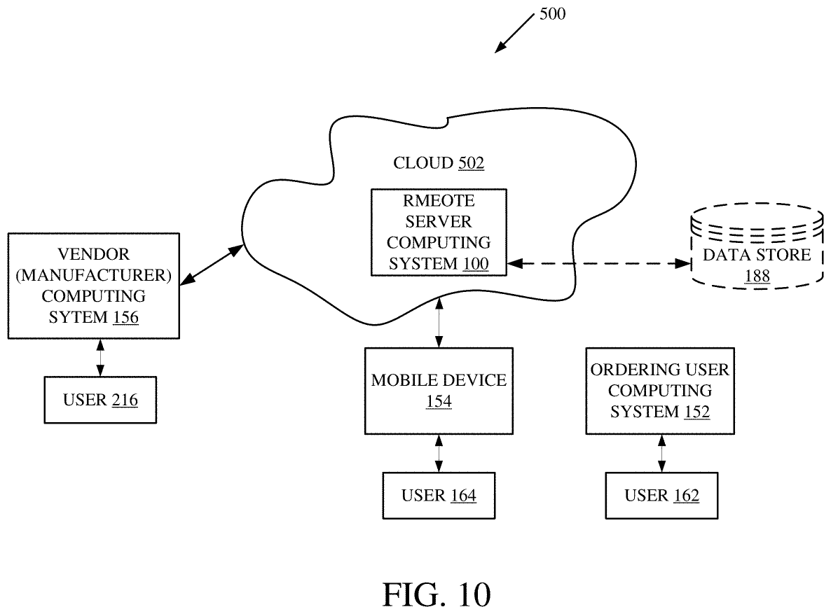

FIG. 10 is a block diagram of architecture 150, shown in FIG. 2, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 150 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 10, some items are similar to those shown in FIG. 2 and they are similarly numbered. FIG. 10 specifically shows that remote server computing system 158 can be located in cloud 502 (which can be public, private, or a combination where portions are public while others are private). Therefore, the users can use mobile device 154 and/or systems 152 and 156 to access those systems through cloud 502.

FIG. 10 also depicts another example of a cloud architecture. FIG. 10 shows that it is also contemplated that some elements of architecture 150 can be disposed in cloud 502 while others are not. By way of example, data store 188 can be disposed outside of cloud 502, and accessed through cloud 502. Regardless of where they are located, they can be accessed directly by devices and systems 152, 154, 156, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 150, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

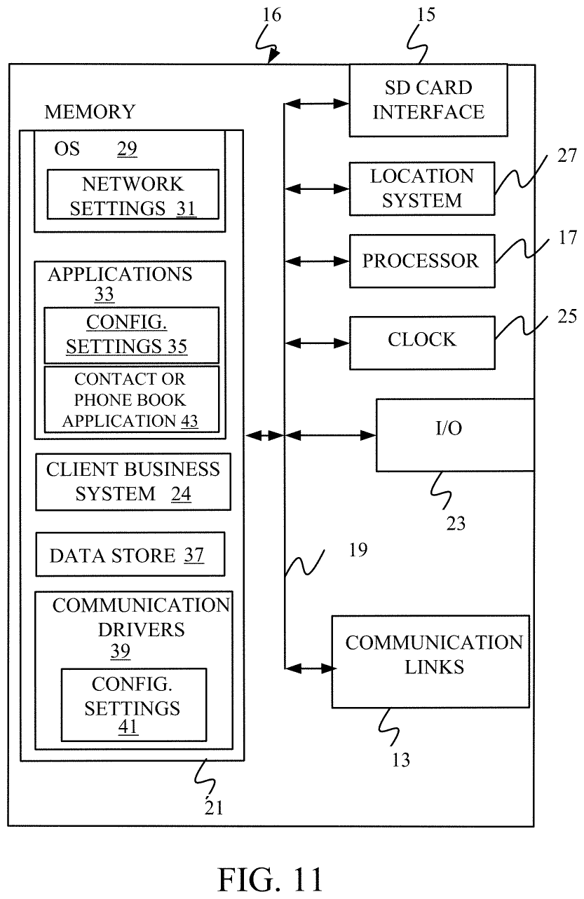

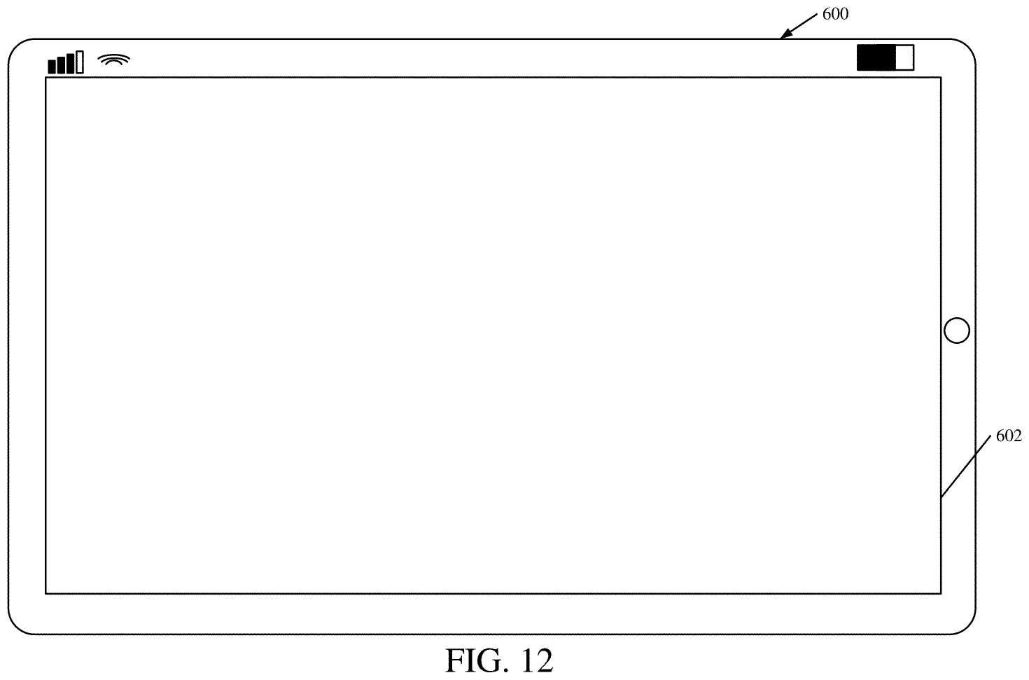

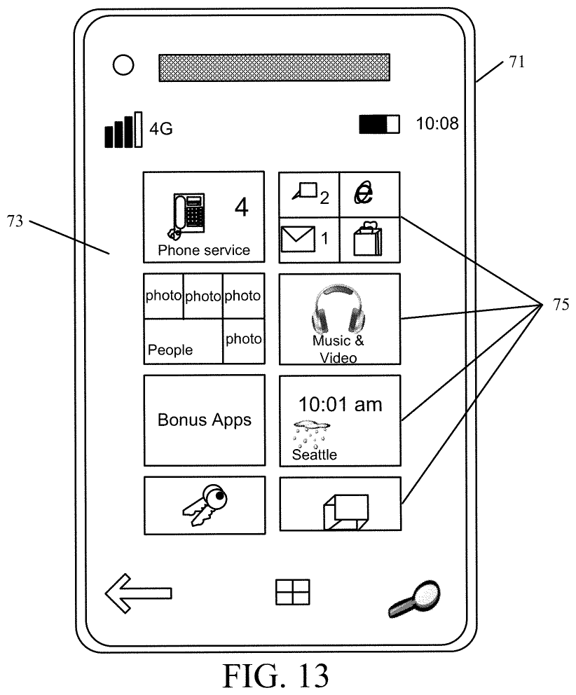

FIG. 11 is a simplified block diagram of one illustrative example of a handheld or mobile computing device (e.g., mobile device 154) that can be used as a user's or client's hand held device 16, in which the present system (or parts of it) can be deployed. FIGS. 12-13 are examples of handheld or mobile devices.

FIG. 11 provides a general block diagram of the components of a client device 16 that can run components of architecture 150 or that interacts with architecture 150, or both. In the device 16, a communications link 13 is provided that allows the handheld device to communicate with other computing devices and under some examples provides a channel for receiving information automatically, such as by scanning. Examples of communications link 13 include an infrared port, a serial/USB port, a cable network port such as an Ethernet port, and a wireless network port allowing communication through one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 12 shows one example in which device 16 is a tablet computer 600. In FIG. 12, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 13 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

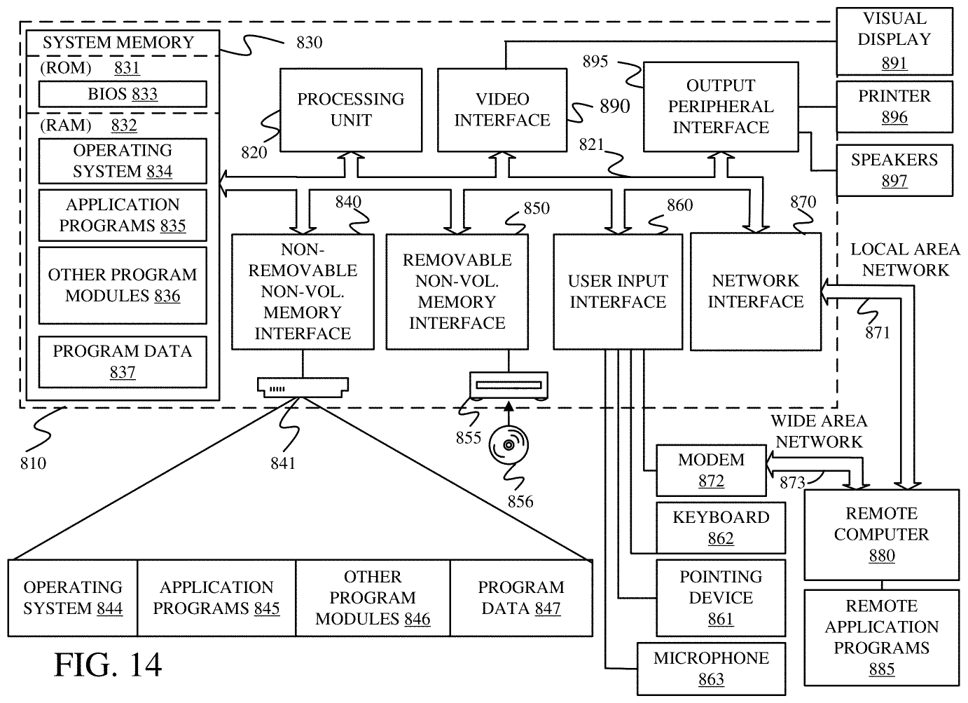

FIG. 14 is one example of a computing environment in which architecture 150, or parts of it, (for example) can be deployed. With reference to FIG. 14, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 2 can be deployed in corresponding portions of FIG. 14.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 14 illustrates operating system 834, application programs 835, other program modules 836, and program data 837.

The computer 810 may also include other removable/non-removable volatile/nonvolatile computer storage media. By way of example only, FIG. 14 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The drives and their associated computer storage media discussed above and illustrated in FIG. 14, provide storage of computer readable instructions, data structures, program modules and other data for the computer 810. In FIG. 14, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 14 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 14 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computing system, comprising:

a part number actuation detector that detects user actuation of a part number actuator, corresponding to a part, on a construction drawing, the construction drawing being indicative of at least a portion of a construction project on a worksite;

part number record retrieval logic that obtains a part number record, indicative of a geographic location of the part;

a worksite location system that correlates the geographic location of the part to a location on the worksite;

overall site display logic that generates site display information indicative of a display of the worksite;

a part visual indicia generator that generates location visual indicia information indicative of a location of the part on the display of the worksite; and

a display generation system that displays the worksite and the visual indicia showing the location of the part on the worksite, based on the site display information and the location visual indicia information.

Example 2 is the computing system of any or all previous examples and further comprising:

a beacon reader configured to read a part identifier from a locator beacon physically attached to the part.

Example 3 is the computing system of any or all previous examples and further comprising:

drawing filter logic configured to filter a set of construction drawings, based on the part identifier, to identify the construction drawing that includes the part.

Example 4 is the computing system of any or all previous examples wherein the part visual indicia generator is configured to generate part visual indicia, on the identified construction drawing, that enhances a visibility of the part on the identified construction drawing.

Example 5 is the computing system of any or all previous examples wherein the part visual indicia generator is configured to generate a visual link between the part on the identified construction drawing and the location of the part on the display of the worksite.

Example 6 is the computing system of any or all previous examples wherein the part visual indicia generator is configured to generate the location visual indicia as a circle around the location of the part on the display of the worksite.

Example 7 is the computing system of any or all previous examples wherein the part visual indicia generator is configured to generate the part visual indicia as a circle around the part on the display of the identified construction drawing.

Example 8 is the computing system of any or all previous examples and further comprising the locator beacon, the locator beacon comprising:

an identifier store storing a part identifier; and

a position sensor configured to sense a geographic position of the locator beacon and generate a position signal indicative of the sensed geographic position.

Example 9 is the computing system of any or all previous examples wherein the locator beacon further comprises:

a movement sensor configured to sense movement of the locator beacon and generate a movement signal indicative of the sensed movement.

Example 10 is the computing system of any or all previous examples wherein the locator beacon further comprises:

a communication system configured to communicate with a hosted locator service at a remote server computing system and with the beacon reader.

Example 11 is the computing system of any or all previous examples wherein the locator beacon further comprises:

wake-up logic configured to intermittently control the communication system to communicate the position signal and the movement signal to the remote server computing system.

Example 12 is a computing system, comprising:

a beacon reader configured to read a part identifier from a locator beacon physically attached to a part to be used at a construction project on a worksite;

drawing filter logic configured to filter a set of construction drawings, based on the part identifier, to identify a construction drawing that includes the part;

a part visual indicia generator that generates part visual indicia, corresponding to the identified construction drawing, that enhances a visibility of the part on the identified construction drawing; and

a display generation system that displays the identified construction drawing with the part visual indicia.

Example 13 is the computing system of any or all previous examples and further comprising:

a part number actuation detector that detects user actuation of a part number actuator, corresponding to a part, on the construction drawing, the construction drawing being indicative of at least a portion of a worksite.

Example 14 is the computing system of any or all previous examples and further comprising:

part number record retrieval logic that obtains a part number record, indicative of a geographic location of the part; and

a worksite location system that correlates the geographic location of the part to a location on the worksite.

Example 15 is the computing system of any or all previous examples wherein the part visual indicia generator is configured to generate location visual indicia information indicative of a location of the part on the display of the worksite.

Example 16 is the computing system of any or all previous examples and further comprising:

overall site display logic that generates site display information indicative of a display of the worksite.

Example 17 is the computing system of any or all previous examples wherein the display generation system is configured to display the worksite and the visual indicia showing the location of the part on the worksite, based on the site display information and the location visual indicia information.

Example 18 is a computer implemented method, comprising:

reading a part identifier from a locator beacon physically attached to a part to be used at a construction project on a worksite;

filtering a set of construction drawings, based on the part identifier, to identify a construction drawing that includes the part;

generating part visual indicia, corresponding to the identified construction drawing, that enhances a visibility of the part on the identified construction drawing; and

displaying the identified construction drawing with the part visual indicia.

Example 19 is the computer implemented method of any or all previous examples and further comprising:

detecting user actuation of a part number actuator, corresponding to a part, on the construction drawing, the construction drawing being indicative of at least a portion of a worksite;

obtaining a part number record, indicative of a geographic location of the part;

correlating the geographic location of the part to a location on the worksite; and

generating location visual indicia information indicative of a location of the part on the display of the worksite.

Example 20 is the computer implemented method of any or all previous examples and further comprising:

generating site display information indicative of a display of the worksite; and displaying the worksite and the visual indicia showing the location of the part on the worksite, based on the site display information and the location visual indicia information.

Although the present invention has been described with reference to preferred embodiments, workers skilled in the art will recognize that changes may be made in form and detail without departing from the spirit and scope of the invention.

What is claimed is:

1. A computing system, comprising:
a part number actuation detector that detects user actuation of a part number actuator, corresponding to a part, on a construction drawing, the construction drawing being indicative of at least a portion of a construction project on a worksite;
part number record retrieval logic that obtains a part number record, indicative of a geographic location of the part;
a worksite location system that correlates the geographic location of the part to a location on the worksite;
overall site display logic that generates site display information indicative of a display of the worksite;
a part visual indicia generator that generates location visual indicia information indicative of a location of the part on the display of the worksite; and
a display generation system that displays the worksite and the visual indicia showing the location of the part on the worksite, based on the site display information and the location visual indicia information.

2. The computing system of claim 1 and further comprising:
a beacon reader configured to read a part identifier from a locator beacon physically attached to the part.

3. The computing system of claim 2 and further comprising:
drawing filter logic configured to filter a set of construction drawings, based on the part identifier, to identify the construction drawing that includes the part.

4. The computing system of claim 3 wherein the part visual indicia generator is configured to generate part visual indicia, on the identified construction drawing, that enhances a visibility of the part on the identified construction drawing.

5. The computing system of claim 4 wherein the part visual indicia generator is configured to generate a visual link between the part on the identified construction drawing and the location of the part on the display of the worksite.

6. The computing system of claim 5 wherein the part visual indicia generator is configured to generate the location visual indicia as a circle around the location of the part on the display of the worksite.

7. The computing system of claim 5 wherein the part visual indicia generator is configured to generate the part visual indicia as a circle around the part on the display of the identified construction drawing.

8. The computing system of claim 2 and further comprising the locator beacon, the locator beacon comprising:
an identifier store storing a part identifier; and
a position sensor configured to sense a geographic position of the locator beacon and generate a position signal indicative of the sensed geographic position.

9. The computing system of claim 8 wherein the locator beacon further comprises:
a movement sensor configured to sense movement of the locator beacon and generate a movement signal indicative of the sensed movement.

10. The computing system of claim 9 wherein the locator beacon further comprises:
a communication system configured to communicate with a hosted locator service at a remote server computing system and with the beacon reader.

11. The computing system of claim 10 wherein the locator beacon further comprises:
wake-up logic configured to intermittently control the communication system to communicate the position signal and the movement signal to the remote server computing system.

12. A computing system, comprising:
a beacon reader configured to read a part identifier from a locator beacon physically attached to a part to be used at a construction project on a worksite;
drawing filter logic configured to filter a set of construction drawings, based on the part identifier, to identify a construction drawing that includes the part;
a part visual indicia generator that generates part visual indicia, corresponding to the identified construction drawing, that enhances a visibility of the part on the identified construction drawing; and
a display generation system that displays the identified construction drawing with the part visual indicia.

13. The computing system of claim 12 and further comprising:
a part number actuation detector that detects user actuation of a part number actuator, corresponding to a part, on the construction drawing, the construction drawing being indicative of at least a portion of a worksite.

14. The computing system of claim 13 and further comprising:
part number record retrieval logic that obtains a part number record, indicative of a geographic location of the part; and
a worksite location system that correlates the geographic location of the part to a location on the worksite.

15. The computing system of claim 14 wherein the part visual indicia generator is configured to generate location visual indicia information indicative of a location of the part on the display of the worksite.

16. The computing system of claim 15 and further comprising:
overall site display logic that generates site display information indicative of a display of the worksite.

17. The computing system of claim 16 wherein the display generation system is configured to display the worksite and the visual indicia showing the location of the part on the worksite, based on the site display information and the location visual indicia information.

18. A computer implemented method, comprising:
reading a part identifier from a locator beacon physically attached to a part to be used at a construction project on a worksite;
filtering a set of construction drawings, based on the part identifier, to identify a construction drawing that includes the part;
generating part visual indicia, corresponding to the identified construction drawing, that enhances a visibility of the part on the identified construction drawing; and
displaying the identified construction drawing with the part visual indicia.

19. The computer implemented method of claim 18 and further comprising:
detecting user actuation of a part number actuator, corresponding to a part, on the construction drawing, the construction drawing being indicative of at least a portion of a worksite;
obtaining a part number record, indicative of a geographic location of the part;
correlating the geographic location of the part to a location on the worksite; and
generating location visual indicia information indicative of a location of the part on the display of the worksite.

20. The computer implemented method of claim 19 and further comprising:
generating site display information indicative of a display of the worksite; and
displaying the worksite and the visual indicia showing the location of the part on the worksite, based on the site display information and the location visual indicia information.
